(19) United States
(12) Patent Application Publication
(10) Pub. No.: US 2023/0110413 A1
(43) Pub. Date: Apr. 13, 2023

(54) SELF-RESETTING LOCK MECHANISM

(71) Applicant: SERDAR PLASTIK SANAYI TICARET A. S., Ankara (TR)

(72) Inventor: Mustafa serdar TUTEK, Ankara (TR)

(73) Assignee: SERDAR PLASTIK SANAYI TICARET A. S., Ankara (TR)

(21) Appl. No.: 17/907,275

(22) PCT Filed: Mar. 30, 2021
(86) PCT No.: PCT/TR2021/050289

§ 371 Date: Sep. 26, 2022

(30) Foreign Application Priority Data
Mar. 31, 2020 (TR) 2020/05084

(51) Int. Cl. A47L 15/42; E05C 19/02

(52) U.S. Cl. CPC A47L 15/4259; E05C 19/024

(57) ABSTRACT

The present invention relates to a lock mechanism that enables the door of the machine to be closed smoothly by the user and the machine can be refunctioned again without any problems, even though the lock latch is in the off position, and is generally designed to be used in all white appliances such as dishwashers and similar machines with doors that require a locking system in home, dining hall, restaurant, hotel, and similar areas of usage.

The present invention relates to lock systems used in all white appliances such as dishwashers and similar machines with doors that require a locking system in houses, dining halls, restaurants, hotels and similar areas of usage.

In cases where the doors of white appliances or similar machines do not close properly, system breakdown problems may be encountered. In machines, the lock may switch to the closed position for several reasons even though the machine door is open. When the machine door is opened, but the lock latch remains in the closed position, the door cannot be closed back. If the machine door is not fully closed and locked, this may put the user in danger and cause environmental pollution since the door remains open while the machine is operating.

One of these situations is that the lock bolt or lock latch is broken due to unknown reasons when the door is forced to be closed by the users, where the locking latch turns to the closed position while the door is open, and the machine door cannot be closed by the users. In such cases, the problems must be solved by calling the technical service and the device cannot be used until it is repaired.

The inventive self-resetting lock mechanism relates to enabling the user to close the door again in all white appliances such as dishwashers or similar machines, without any problem even if the lock is in the closed position.

### TECHNICAL FIELD OF THE INVENTION

The present invention is designed to be used in all white appliances such as dishwashers and similar machines with doors that require a locking system at homes, dining halls, restaurants, hotels, and similar areas of usage, and relates to the lock mechanism that allows the machine to restart without any problem, in which the machine door can be closed smoothly by the user, even if the lock latch is closed.

### STATE OF THE ART

In the state of art, due to the motion occurring as the door lock on the machines is being opened and closed each time, the mechanical problems such as the locking latch is getting stuck and the latch is not being able to lock, may occur and it wear down over time as a result of long-term or heavy use. Problems such as non-locking, loosening, dislocation etc. can be observed in the locking system. These kinds of problems may cause the machine door not to be closed normally, thereby resulting in water leakage, short circuit, or machine breakdowns. The case of the doors of the machines not being closed properly may be caused by an extraneous object adhered/stuck to this area. If there is no such object, it means that there is a technical or a structural problem in the machine. In order to find the source of the problem, it will be required to check the lock/gasket and similar systems on the machine, respectively. Such problems cause time and labor loss during the machine use.

### BRIEF DESCRIPTION OF THE INVENTION

The present invention relates a thermoplastic locking group having the feature of self-resetting, that can be used in all white appliances such as dishwashers and similar machines with doors that require a lock system at homes, dining halls, restaurants, hotels, and similar areas of usage, that may be grouped identically with the reserved area for a standard door locking component, without requiring any alteration or modification in the other parts than the locking group, without the body shape/structure creating an alteration which will create a risk/error in the operation of the system. The present invention relates to converting the horizontal movement which is caused due to the lock bolt being triggered, into vertical movement in the lock bolt recess in the motion path (5) located on the lock body (1), where the prevalent compression spring (3) of the self-resetting locking group being used, without rotating the locking latch (2) on the lock body (1), in the stage of closing the door of all the machines with door systems.

### BRIEF DESCRIPTION OF THE FIGURES

FIG. 1 illustrates the front view of the inventive self-resetting lock mechanism.

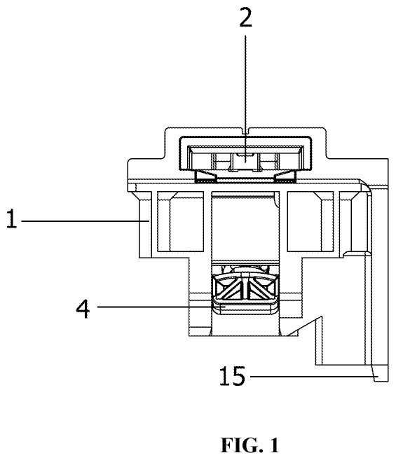

FIG. 2 illustrates the rear view of the inventive self-resetting lock mechanism.

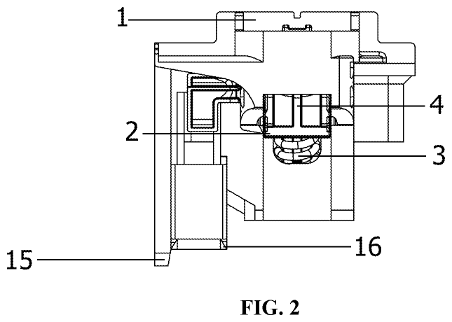

FIG. 3 illustrates the top view of the inventive self-resetting lock mechanism.

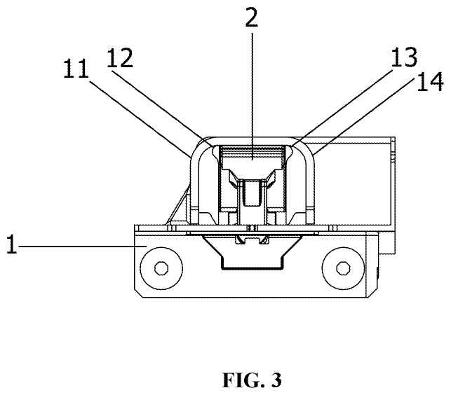

FIG. 4 illustrates the right view of the inventive self-resetting lock mechanism.

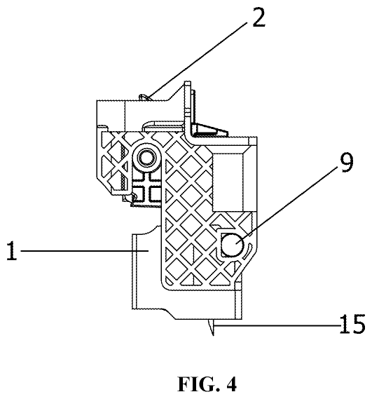

FIG. 5 illustrates the left view of the inventive self-resetting lock mechanism.

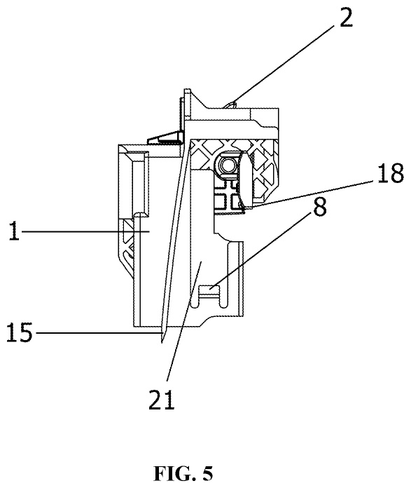

FIG. 6 illustrates the front perspective view of the inventive self-resetting lock mechanism.

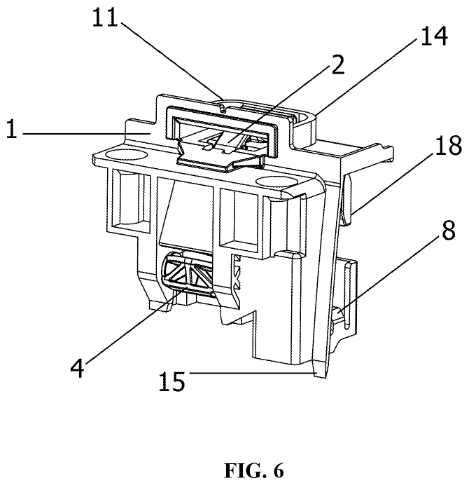

FIG. 7 illustrates the rear perspective view of the inventive self-resetting lock mechanism.

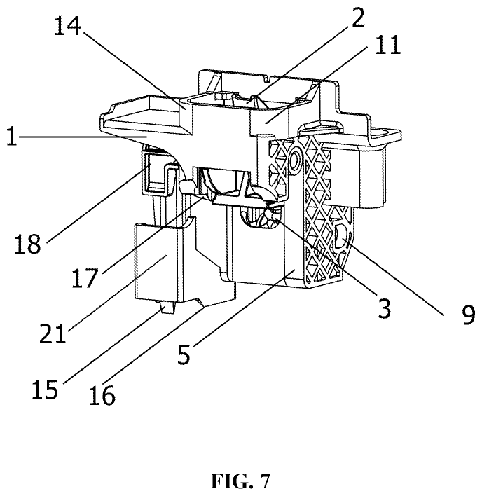

FIG. 8 illustrates the bottom perspective view of the inventive self-resetting lock mechanism.

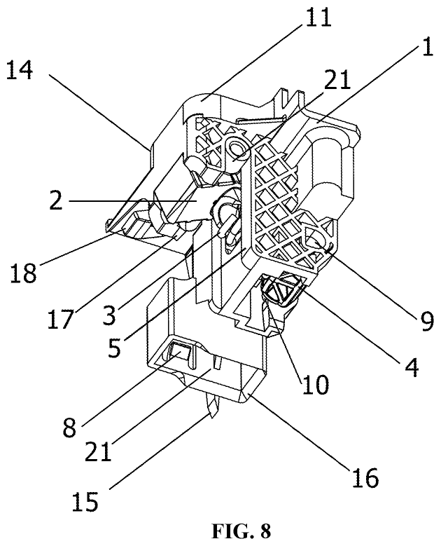

FIG. 9 illustrates the sectional view of the inventive self-resetting lock mechanism.

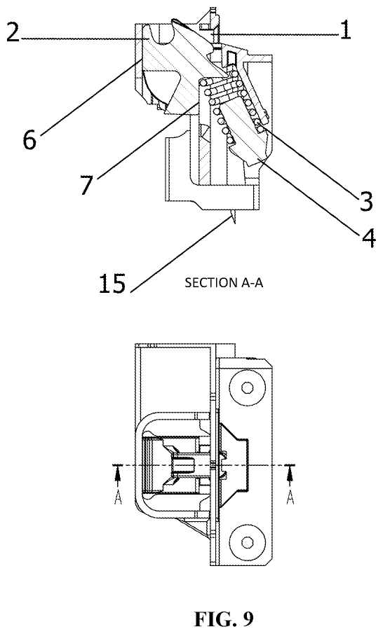

FIG. 10 illustrates the exploded view of the inventive self-resetting lock mechanism.

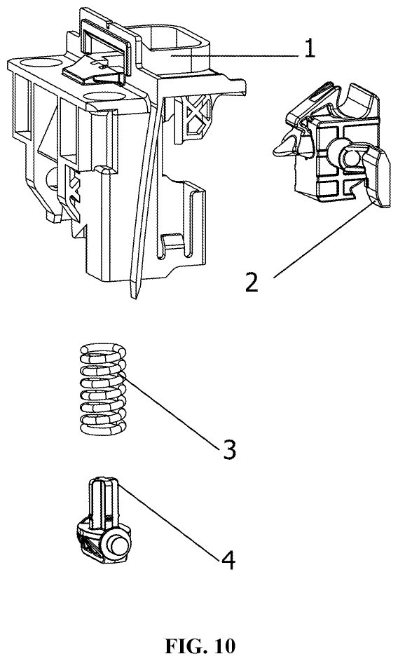

FIG. 11 illustrates the locking latch of the inventive self-resetting lock mechanism.

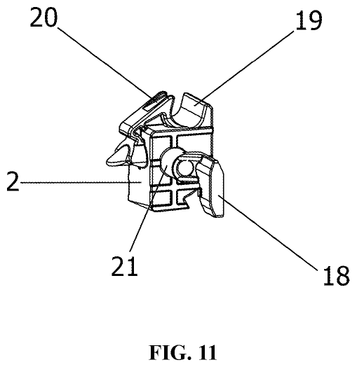

### REFERENCE NUMERALS

1. Lock Body

2. Locking Latch

3. Compression Spring

4. Spring Retainer

### PART DETAILS SPECIFIED IN THE REFERENCES

5. Motion Path

6. External Sliding Surface

7. Internal Sliding Surface

8. Switch Retaining Tab

9. Big Assembly Hole of Spring Retainer

10. Small Assembly Hole of Spring Retainer

11, 12, 13, 14 - Radius (Rounded Corner)

15, 16, 17, 18 - Capillarity Method (Sharp Corner Method)

18. Side Wing

19. Rear Tab

20. Ramped Tab

21. Lock Latch Pins

### DETAILED DESCRIPTION OF THE INVENTION

The present invention relates to a self-resetting lock mechanism, which has a body strengthened with the tie piece and is lightweight, performing the self-reset function by using compression spring (3) of the existing mechanism, without the requirement for an additional spring, consisting of three parts except compression spring (3), easily grouped and benefitting from the action of compression spring (3), has a resistance to high temperatures, low temperatures, chemicals and pressure, produced by thermoplastic material entirely except for the compression spring (3). The present invention is a locking mechanism capable of self-resetting, characterized in that, it comprises a lock body (1), a locking latch (2), a compression spring (3), and a spring retainer (4).

The lock mechanism, in all white appliances such as dishwashers and similar machines with doors, opens a switch when the machine door is closed. The respective switch activates the time counter and the control panel. The control panel is active, and the switch is open when the door is closed. Thus, when the door is open, the machine does not work, and undesired situations are not experienced. However, if a problem occurs in the door switch and it does not work properly, the automatic control system and control panel of the machine will not be activated and it will not operate.

The present invention is a lock system that is grouped with locking latch (2) placed on lock body (1), compression spring (3) and spring retainer (4). The lock bolt on the device, which enables the machine door to be locked, switches the lock to the off position by coming into contact with external sliding surface (6), and internal sliding surface (7), rotates in the recess (axis) in which the pins (21) of the locking latch (2) positioned on the motion path (5) on the lock body (1) are placed, and pushes the rear tab (19) on locking latch (2) when the door is closed.

When the door opens, locking latch (2) gets released from the lock bolt, rotating in the recesses (axis) in which the locking latch (2) pins (21) are placed on the motion path (5) on the lock body, by pulling ramped tab (20) thereon. While the door is in the open position, in case the lock latch (2) switched to off position due to an external effect, the lock system in available systems prevents the door from being closed, if the door is required to be closed. However, the present invention is characterized by preventing problems on the machine and switching to the locked position that will allow the system to operate, enabling the lock bolt to be re-attached by sliding on internal sliding surface (7) and external sliding surface (6) of the lock latch (2), by stretching the compression spring (3) with the vertical movement creating within motion path (5), pushing ramped tab (20) on lock latch (2) in the recess on lock body (1) of the lock bolt, even if it remains in the off position.

In order to prevent the body from breaking, when locking latch (2) hits the body, the corners of the sliding surfaces on the body of locking latch (2) are formed in a structure with radius (rounded corners) (11,12,13,14) inside and outside In this way, no matter how fast the lock latch hits the body, the body is stretched and not broken.

In the lock body (1) of the inventive self-resetting lock mechanism which is the subject of the invention; The locking latch (2) is the main part where compression spring (3), and the spring retainer (4) is assembled. Locking latch (2): Works with the trigger of the lock bolt and has the function of locking and opening the door. Compression spring (3): Creates the power that actuating the system. The spring retainer (4), on the other hand, is the part that enables the compression spring (3) to perform its opening-closing and self-resetting functions in a controlled manner with its back and forth flexing movement.

The movement of locking latch (2) starts with the triggering of the lock bolt on the machine, the lock bolt stretches by pushing locking latch (2) and pressing compression spring (3), lock bolt is placed on the locking latch (2) and completes the locking process. At this stage, the side wing (18) on the locking latch (2) signals the machine that the door is in closed position by pressing the button on the switch.

There is a switch retaining tab (8) in the switch recess located in the lock body (1). While the switch is inserted into its place, the switch retaining tab (8) stretches and allows the switch to enter its recess; as soon as the switch is placed in its place, the switch retaining tab (8) returns to its former position. Thus, switch does not exit from the switch recess. In the state of art, while the switch is fastened through the pin holes; the present invention is characterized by fastening (fixing) with a single tab (8) on the body without using the assembling pin holes on the switch.

The present invention is further characterized by directing water away from the switch by using capillarity technique (sharp corner technique) (15,16,17) on the side walls of the switch so that the water intrusion through the device door does not reach the active ends of the switch. Capillarity technique (sharp corner technique) (15,16,17) structures is formed with sharp edges and pointed ends, which enables to the water flow away from the switch in a controlled manner, without allowing the water intrusion through the door to accumulate or hold on at any point on the mechanism.

The present invention is further characterized in that the lock can operate by using the existing compression spring (3) without requiring an additional spring in the machine which uses a self-resetting lock mechanism. By means of the SR2 Self-Resetting Lock Group, it can be ensured that refunction of the machine with self-resetting feature, in which the locking latch (2) of a device door can return to the locked position for any reason, in case the door cannot be locked. In the state of art, 2 combined mechanisms are operated on the lock group representing these two functions, and therefore, 2 springs must be used. This increases the price and complexity of the machine or product being used. The inventive self- resetting locking mechanism uses the same spring for both functions as described, and is characterized by avoiding the requirement of a second spring.

The compression spring (3) located in the lock body (1) is characterized in that; the locking latch (2) can perform the opening and closing movement through a single spring by stretching at two different angles by means of its structure that enables movement in two different directions; on the axis in which spring retainer (4) is connected, during the self- resetting function.

The self-resetting lock mechanism enables a single compression spring (3) to perform the movement of the locking latch (2) by stretching at two different angles, as well as its self-resetting function, by means of this feature of the spring retainer (4) that can move in two directions.

The present invention is characterized by preventing incorrect grouping of the lock mechanism by creating a poke/yoke in the spring retainer joint area, due to the fact that the spring retainer recess is designed to operate with a single action core, by using the diameter differences of big assembly hole of spring retainer (9) and small assembly hole of spring retainer (10) in the lock body (1)

What is claimed is:

1. A self-resetting lock mechanism used in all white appliances and similar machines with doors that require a lock system, characterized in that; opening and closing motion is performed via a single spring by means of the structure of the compression spring (3) located in the lock body (1), which not only enables the opening and closing motion of the locking latch (2) but also a movement in two different directions on the axis to which the spring retainer (4) is connected during the self-resetting function that resets itself

2. A self-resetting lock mechanism that resets itself, according to the claim 1, characterized in that; the spring retainer (4) enables an compression spring (3) to perform both the movement of locking latch (2), and its self-resetting function by stretching at two different angles, by means of the ability of moving in two directions.

3. A self-resetting lock mechanism that resets itself according to claim 1, characterized in that; it allows for closing the door by moving to the correct position again upon the triggering of the lock bolt in case the lock latch (2) remains in off position due to any effect even if the lock latch (2) is in closed position.

4. A self-resetting lock mechanism that resets itself according to the claim 1, characterized in that; the lock and the self-resetting lock mechanism operate by using the existing compression spring (3) without requiring an additional spring.

5. A self-resetting lock mechanism that resets itself, according to claim 1, characterized in that; said self-resetting lock mechanism that resets itself consists of three parts except for the compression spring (3) and can be grouped manually.

6. A self-resetting lock mechanism that resets itself according to claim 1, characterized in that; the switch is fastened (fixed) with a single switch retaining tab (8) on the body, without using the assembling pin holes on the switch.

7. A self-resetting lock mechanism that resets itself, according to claim 1, characterized in that; no metal is used in the body thereof other than the spring (3) and all parts except the spring (3) are formed of thermoplastic material.

8. A self-resetting lock mechanism that resets itself, according to claim 1, characterized in that; it prevents incorrect grouping of the lock mechanism by creating a poke/yoke in the spring retainer joint area, as the spring retainer recess is designed to operate with a single action core, by using the diameter differences of big assembly hole of spring retainer (9) and small assembly hole of spring retainer (10) in the lock body (1).

9. A self-resetting locking mechanism that resets itself according to claim 1, characterized in that; the body (1) stretches and does not break regardless of the power of the impact of the locking latch (2) on the body (1) by means of by shaping the corners of sliding surfaces on the locking latch (2) such that said corners have radius both on the inside and on the outside (rounded corners) (11, 12, 13, 14) so that the locking latch (2) does not break the body once it hits thereto when the lock is in closed position.

10. A self-resetting locking mechanism that resets itself according to claim 1, characterized in that; it directs water away from the switch by using capillarity technique (sharp corner technique) (15,16,17) on the side walls of the switch so that the water intrusion through the device door does not reach the active ends of the switch.
